(19) United States
(12) Patent Application Publication
(10) Pub. No.: US 2017/0293970 A1
(43) Pub. Date: Oct. 12, 2017

(54) FITTING METHOD AND FITTING DEVICE FOR FITTING IN VIRTUAL

(71) Applicant: SHENZHEN WISDOW FORMING SCIENCE AND TECHNOLOGY DO., LTD., Shenzhen (CN)

(72) Inventors: QiuYan ZENG, Shenzhen (CN); TangSheng LEI, Shenzhen (CN)

(73) Assignee: SHENZHEN WISDOW FORMING SCIENCE AND TECHNOLOGY DO., LTD., Shenzhen (CN)

(21) Appl. No.: 15/323,952

(22) PCT Filed: Jan. 20, 2016
(86) PCT No.: PCT/CN2016/071490

§ 371 Date: Jan. 4, 2017

(30) Foreign Application Priority Data
Nov. 30, 2015 (CN) 201510861086.1

(51) Int. Cl. G06Q 30/06; G06K 1/12

(52) U.S. Cl. CPC G06Q 30/0643; G06K 1/121

(57) ABSTRACT

An image processing method for a unmanned aerial vehicle includes: aligning a subject matter by a camera of the unmanned aerial vehicle; focusing on the subject matter at a first time, and recording images information in a focus frame as a first reference pattern; presetting a separation distance of automatic movement of the unmanned aerial vehicle, focusing on the subject matter at a second time, and recording image information in the focus frame as a second reference pattern; synthesizing a three-dimensional reference pattern of the subject matter according to the first reference pattern and the second reference pattern; automatically traversing images in whole camera aperture by the focus frame when the unmanned aerial vehicle detects interrupt of controlling signal, and comparing with the three-dimensional reference pattern, if the subject matter can't be found, location of the unmanned aerial vehicle is automatically adjusted until the subject matter reappears on the camera aperture; presetting a reference straight line between the camera and the subject matter, controlling movement of the unmanned aerial vehicle along the reference straight line, and monitoring moving state of the unmanned aerial vehicle via a three-axis gyroscope; if the unmanned aerial vehicle deviates from the reference straight line in flight, a new reference straight line is represetted and the movement of the unmanned aerial vehicle along the new reference straight line is controlled; obtaining distance of movement of the unmanned aerial vehicle along the reference straight line via the three-axis gyroscope, and recording a ratio of display widths of the subject matter before the camera is moving and after the camera is moving, and calculating measuring distance between the camera and the subject matter; if the measuring distance is more than a presetting reference distance, the unmanned aerial vehicle is controlled to move to subject matter until the measuring distance is less than or equal with the presetting reference distance.

### TECHNICAL FIELD

The present disclosure relates to clothes field, and more particularly to a fitting method and a fitting device for fitting in a virtual environment.

### BACKGROUND

With bight-speed development of e-commerce and popularization of an internet, it is one of normal life-styles to buy clothes on the internet. However, it is difficult to effectively show real effect when you really wear the clothes from the internet when people only depends on plane display of the clothes on the internet. In addition, different styles of the clothes having a same size also have differences. Buyers wear the clothes when they get the clothes that they buy on the internet and find the clothes do not fit well, which makes buyer experience feel bad, furthering increasing a refund rate of the clothes on the internet and cost of internet merchants. It is no benefit for the internet merchants and the buyers. At present, many online stores public detail size of the clothes and show a reference range depending on stature and weight. However, bodily forms of peple have difference, the above reference data cannot give accurate reference opinion for the buyers.

### BRIEF DESCRIPTION OF FIGURES

FIG. 1 is a schematic diagram of a fitting method for fitting in a virtual environment of the present disclosure.

FIG. 2 is a schematic diagram of a fitting device for fitting in the virtual environment of the present disclosure.

### DETAILED DESCRIPTION

The aim of the present disclosure is to provide a fitting method and a fitting device for fitting in a virtual environment capable of estimating whether clothes fit well.

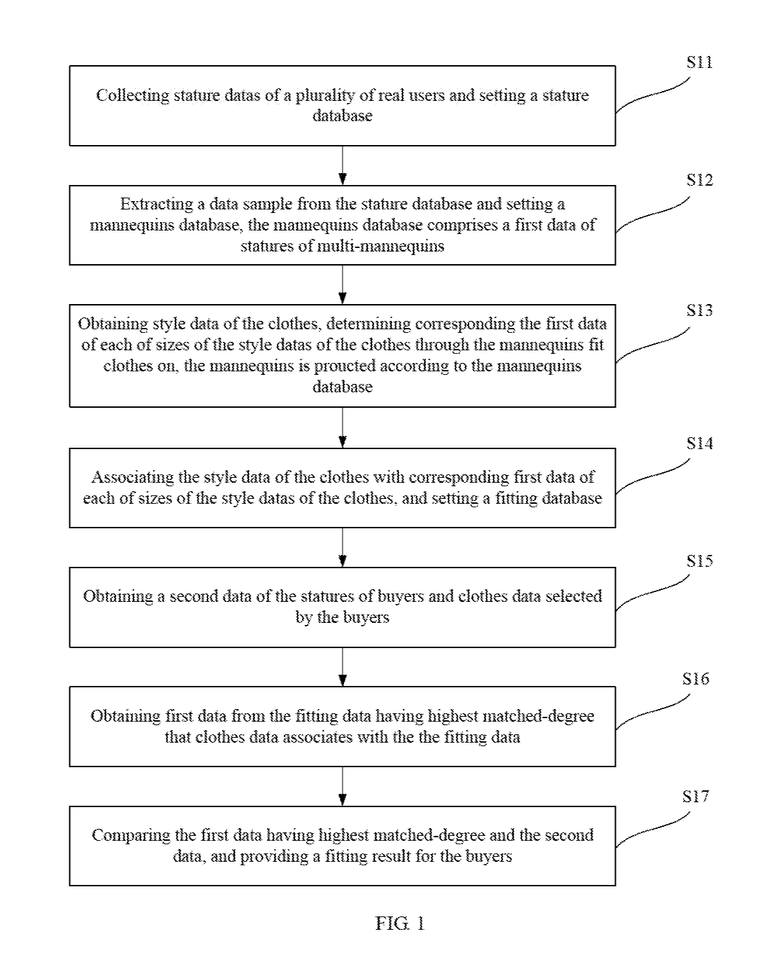

As shown in FIG. 1, The fitting method for fitting in the virtual environment, comprising:

S11: collecting stature datas of a plurality of real users and setting a stature database;

S12: extracting a data sample from the stature database and setting mannequins database, the mannequins database comprises a first data of statures of multi-mannequins;

S13: obtaining style data of the clothes, determining corresponding the first data of each of sizes of the style datas of the clothes through the mannequins fit clothes on, the mannequins is proucted according to the mannequins database;

S14: associating the style data of the clothes with corresponding first data of each of sizes of the style datas of the clothes, and setting a fitting database;

S15: obtaining a second data of the statures of buyers and clothes data selected by the buyers;

S16: obtaining first data from the fitting data having highest matched-degree that clothes data associates with the the fitting data; and

S17:comparing the first data having highest matched-degree and the second data, and providing a fitting result for the buyers.

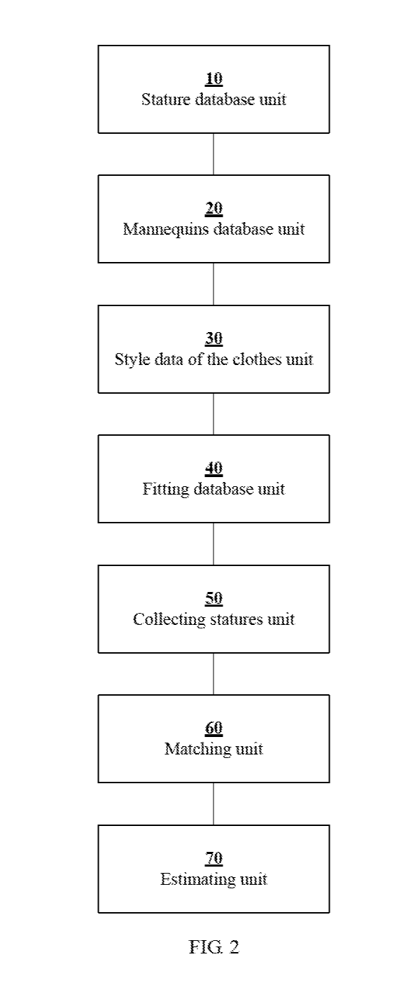

As shown FIG. 2, a fitting device for fitting in the virtual fitting room of the present disclosure comprises

a stature database unit 10 collecting the stature datas of a plurality of the real users and setting the stature database;

a mannequins database unit 20 extracting the data sample from the stature database and setting the mannequins database, the mannequins database comprises the first datas of the statures of multi-mannequins;

a style data of the clothes unit 30 obtaining style data of the clothes, determining corresponding first data of each of sizes of the style datas of the clothes through the mannequins fit clothes on, the mannequins proucted according to the mannequins database:

a fitting database unit 40 associating the style data of the clothes with corresponding first data of each of sizes of the style datas of the clothes, and setting the fitting database;

a collecting statures unit 50 obtaining second data of the statures of buyers and clothes data selected by the buyers;

a matching unit 60 obtaining the first data from the fitting data having highest matched-degree that clothes data associates with the the fitting data;

a estimating unit 70 comparing the first data having highest matched-degree and the second data, and providing the fitting result for the buyers.

In the present disclosure, the first data is the stycle data of the closes and mannequins data dining manufacturing or selling process, the second data is the stature data of the buyers submitted by the buyers. And the buyers chooses the clothes that they want to buy, and the first data having highest matched-degree is found according to the data of the clothes that the buyer want to buy, the first data is compared with the second data to determine whether clothes fit well. The present disclosure only stores the representative mannequins data without comparing data of the statures of buyers with clothes data and showing data statures fitted by each of style of the clothes, which decreases a plurality of data and ensuring accuracy. In addition, the present disclosure set the stature database that is independent with the fitting database needed by the buyers. With increase of number of collecting sample, the first data is determined and universality. The present disclosure has moer broad space, for upgrading without affecting normal operation. The buyers can accurately judge whether the clothes fit without trying on by theirself.

The fitting method (some are shown in the flow chart of the figure) of the present disclosure is achieved by hardware, software, firmware, middleware, microcode, hardware description language (HDL) or arbitrary combination of them. When the software, the firmware, the middleware, or the microcode are used to achieve the fitting method, procedure code and code segment that achieves a necessary task are stored in a machine or a readable medium of the computer(such as storage medium), and one or more processors can achieve the necessary task.

Specific structure and detailed function of the present disclosure are only representative and are used to describe the example. However, it should be understood that other replaced ways to achieve the fitting method and the present disclosure is not limited to the specific example.

In addition, in some of the replaced ways may refer that sequence of some functions and actions can be operation, where the sequence is different with sequence of tables of the FIGS. For example, depending on related some functions and actions, the two FIGS. shown in succession may in fact be executed substantially simultaneously or at times may be executed in reverse order.

The present disclosure will be described in detail in accordance with the figures and the examples.

The fitting method in the virtual environment, comprising:

collecting stature datas of a plurality of real users and setting a stature database;

extracting a data sample from the stature database and setting a mannequins database, the mannequins database comprises first datas of statures of multi-mannequins;

obtaining style data of the clothes, determining, corresponding first data of each of sizes of the datas of the clothes through the mannequins fit clothes on, the mannequins is proucted according to the mannequins database;

associating the style data of the clothes with corresponding first data of each of sizes of the style datas of the clothes, and setting a fitting database;

obtaining second data of the statures of buyers and clothes data selected by the buyers;

obtaining first data from the fitting data having highest matched-degree that clothes data associates with the the fitting data; and

comparing the first data having highest matched-degree and the second data, and providing a fitting result for the buyers.

To be specific, method for obtaining the second data of the statures of buyers and the clothes data selected by the buyers comprising:

obtaining buyer's ID;

looking up historical records and shopping evaluation records according to the buyer's ID; and,

generating second data according to the historical records and the shopping evaluation records.

Furthermore, a method for generating second data according to the historical records and the shopping evaluation records comprising:

finding records for buying the clothes from the historical records;

obtaining evaluation for dimension of each of the bought clothes from the shopping evaluation records;

taking a weighted average for the dimension of each of the bought clothes having eligible evaluation, and obtaining dimension data as the second data.

Each of the buyers has one unique ID at a electric business platform. For all-around electric business platform, the buyers may buy all kinds of stuff, such a clothes, shoes, phones, makeups. Therefore, first, records for buying the clothes are found from the historical records, and evaluations of the buyers are read, if the evaluations show the bought clothes fit well, and size data of the bought clothes are extracted. The size data includes but not limited to clothes length, front clothes length, back clothes length, neck line, transverse shoulder breadth, neck shoulder point, neck front point, neck back point, neck end point, shoulder end point, chest measurement, chest depth, nipple dot spacing, nipple under the peak, large encircling the shoulder width, thickness of the shoulder width, shoulder, back-wide, backing thickness, back long, large arm, the toggle encircling the circumference of the cuff long, the cuff fat, the cuff, the sleeve thick, which circumferential length of the sleeve to the wrist circumference of, the rear long, the total length of the front long, the emulsion to sag, waist high, a lower profile long, a vertical gear long, the rotator cuff is long, the clothes long, the knee long, the skirt length, the length of the pants to, waist circumference, the swing encircling, the lower swing, hip circumference, the circumference at hips, the length of the pants, thigh, encircling, to the calves, encircling, knee, encircling, feet, opening, a front, rear wave.

Size data of the fitted clothes bought by the buyers are extracted to average, for example, there are two fitted clothes bought by the buyers, clothes length of the first clothes is 67 cm, clothes length of the second clothes is 69 cm, thus, the clothes length of the buyer is 68 cm.

According the above technical scheme, the buyer can obtain accurate second data without inputting stature data of the buyer. Even through some online store can store the stature data of the buyer, taking the buyer measure is rough for the common buyers. Form the above example that size data of the clothes, the accurate second data is obtained, which requires to measure more data. It is not practical to make the common buyer measure. However, for the present disclosure, the buyers only initially provide brief data, such as height, weight without measuring by theirselves. The accuracy of the second data is more and more high when the amount of the clothes bought by the buyer increases.

Optionally, the first data comprises reference waistline data and the second data comprises the buyer waistline data. The first data is compared with the seond data, the method for feedbacking fitting result to the buyer comprises:

comparing the reference waistline data with the buyer waistline data;

if difference value between the reference waistline data and the buyer waistline data is in preset interval, the fitting result is fit; if the difference values exceeds unpper limit value of the preset interval, the fitting result is that waistline data is too narrow; if the difference values exceeds lower limit value of the preset interval, the fitting result is that waistline data is too long.

Optionally, the first data comprises reference shoulderbreadth and the second data comprises the buyer shoulderbreadth. The first data is compared with the seond data, the method for feedbacking fitting result to the buyer comprises:

comparing the buyer shoulderbreadth with the reference shoulderbreadth;

if difference value between the reference shoulderbreadth and the buyer shoulderbreadth is in preset interval, the fitting result is fit; if the difference values exceeds unpper limit value of the preset interval, the fitting result is that shoulderbreadth is too narrow; if the difference values exceeds lower limit value of the preset interval, the fitting result is that shoulderbreadth is too wide.

Optionally, the first data comprises reference chest circumference and the second data comprises the buyer chest circumference. The first data is compared with the seond data, the method for feedback fitting result to the buyer comprises:

comparing the buyer chest circumference with the reference chest circumference;

if difference value between the reference chest circumference and the buyer chest circumference is in preset interval, the fitting result is fit; if the difference values exceeds unpper limit value of the preset interval, the fitting result is that chest circumference is too narrow; if the difference values exceeds lower limit value of the preset interval, the fitting result is that chest circumference is too wide.

Furthermore, the above compared data is regarded as one set of data, and is regarded as more sets of data to compare, which can be comprehensive determination It should be understood that other reference such as waistband width, arch of the foot also can be compared. The compared data is more, the fitting result is more detail and more accuracy, there will be no description.

In order to simplify inputting data of the fitting database, QR code corresponding to the first data one by one can be printed on the mannequin. When the mannequin fits well, the QR code is scaned, namely the first data corresponding the mannequin is input to the database and is associated with corresponding data of each of sizes of the style datas of the clothes, which simplifies work inputting data.

As other embodiment of the present disclosure, the fitting device for fitting in the virtual fitting room of the present disclosure comprises

a stature database unit collecting the stature datas of a plurality of the real users and setting the stature database;

a mannequins database unit extracting the data sample from the stature database and setting the Mannequins database, the mannequins database comprises the first datas of the statures of multi-mannequins;

a style data of the clothes unit obtaining style data of the clothes, determining corresponding first data of each of sizes of the style datas of the clothes through the mannequins fit clothes on, the mannequins is proucted according to the mannequins database;

a fitting database unit associating the style data of the clothes with corresponding first data of each of sizes of the style datas of the clothes, and setting the fitting database;

a collecting statures unit obtaining second data of the statures of buyers and clothes data selected by the buyers;

a matching unit obtaining the first data from the fitting data having highest matched-degree that clothes data associates with the the fitting data;

a estimating unit comparing the first data having highest matched-degree and the second data, and providing the fitting result for the buyers.

To be specific, the collecting statures unit further comprises:

an ID obtaining unit obtaining buyer's ID;

a looking up record unit looking up historical records and shopping evaluation records according to the buyer's ID; and

a generating data unit generating second data according to the historical records and the shopping evaluation records.

Furthermore, the generating data unit is configured as:

finding records for buying the clothes from the historical records;

obtaining evaluation for dimension of each of the bought clothes from the shopping evaluation records;

taking a weighted average for the dimension of each of the bought clothes having eligible evaluation, and obtaining dimension data as the second data.

The fitting method for fitting in the virtual environment of the above embodiment can be realized by the fitting device for fitting in virtual environment of the embodiment.

The present disclosure is described in detail in accordance with the above contents with the specific preferred examples. However, this present disclosure is not limited to the specific examples. For the ordinary technical personnel of the technical field of the invention, on the premise of keeping the conception of the present disclosure, the technical personnel can also make simple deductions or replacements, and all of which should be considered to belong to the protection scope of the present disclosure.

1. A fitting method for fitting in a virtual environment, comprising:
collecting stature datas of a plurality of real users and setting a stature database;
extracting a data sample from the stature database and setting a mannequins database, the mannequins database comprises a first data of statures of multi-mannequins;
obtaining style data of the clothes, determining corresponding the first data of each of sizes of the style datas of the clothes through the mannequins fit clothes on, the mannequins is proucted according to the mannequins database;
associating the style data of the clothes with corresponding first data of each of sizes of the style datas of the clothes, and setting a fitting database;
obtaining a second data of the statutes of buyers and clothes data selected by the buyers
obtaining first data from the fitting data having highest matched-degree that clothes data associates with the the fitting data; and,
comparing the first data having highest matched-degree and the second data, and providing a fitting result for the buyers.

2. The fitting method for fitting in the virtual environment of claim 1, wherein method for obtaining the second data of the statures of buyers and the clothes data selected by the buyers comprising:
obtaining buyer's ID;
looking up historical records and shopping evaluation records according to the buyer's ID; and,
generating second data according to the historical records and the shopping evaluation records.

3. The fitting method for fitting in the virtual environment of claim 2, wherein the method for generating second data according to the historical records and the shopping evaluation records comprising:
finding records for buying the clothes from the historical records;
obtaining evaluation for dimension of each of the bought clothes from the shopping evaluation records; and
taking a weighted average for the dimension of each of the bought clothes having eligible evaluation, and obtaining dimension data as the second data.

4. The fitting method for fitting in the virtual environment of claim 3, wherein QR code corresponding to the first data one by one can be printed on the mannequin, a method for setting the fitting database comprises: associating the style data of the clothes with corresponding data of each of sizes of the style datas of the clothes via scanning the QRcode of the mannequin.

5. The fitting method for fitting in the virtual environment of claim 4, wherein the first data comprises reference waistline data and the second data comprises the buyer waistline data. The first data is compared with the seond data, the method for feedbacking fitting result to the buyer comprises:
comparing the reference waistline data with the buyer waistline data;
if difference value between the reference waistline data and the buyer waistline data is in preset interval, the fitting result is fit; if the difference values exceeds unpper limit value of the preset interval, the fitting result is that waistline data is too narrow; if the difference values exceeds lower limit value of the preset interval, the fitting result is that waistline data is too long.

6. The fitting method for fitting in the virtual environment of claim 5, wherein the first data comprises reference shoulderbreadth and the second data comprises the buyer shoulderbreadth. The first data is compared with the seond data, the method for feedbacking fitting result to the buyer comprises:
comparing the buyer shoulderbreadth with the reference shoulderbreadth;
if difference value between the reference shoulderbreadth and the buyer shoulderbreadth is in preset interval, the fitting result is fit; if the difference values exceeds unpper limit value of the preset interval, the fitting result is that shoulderbreadth is too narrow; if the difference values exceeds lower limit value of the preset interval, the fitting result is that shoulderbreadth is too wide.

7. The fitting method for fitting in the virtual environment of claim 1, the first data comprises reference chest circumference and the second data comprises the buyer chest circumference. The first data is compared with the seond data, the method for feedbacking fitting result to the buyer comprises:
comparing the buyer chest circumference with the reference chest circumference;
if difference value between the reference chest circumference and the buyer chest circumference is in preset interval, the fitting result is fit; if the difference values exceeds unpper limit value of the preset interval, the fitting result is that chest circumference is too narrow; if the difference values exceeds lower limit value of the preset interval, the fitting result is that chest circumference is too wide.

8. A fitting device for fitting in a virtual environment, comprising:
a stature database unit collecting the stature data of a plurality of the real users and setting the stature database;
a mannequins database unit extracting the data sample from the stature database and setting the mannequins database, the mannequins database comprises the first datas of the statures of multi-mannequins;
a style data of the clothes unit obtaining style data of the clothes, determining corresponding first data of each of sizes of the style datas of the clothes through the mannequins fit clothes on, the mannequins is proucted according to the mannequins database;
a fitting database unit associating the style data of the clothes with corresponding first data of each of sizes of the style datas of the clothes, and setting the fitting database;
a collecting statures unit obtaining second data of the statures of buyers and clothes data selected by the buyers;
a matching unit obtaining the first data from the fitting data having highest matched-degree that clothes data associates with the the fitting data; and
a estimating unit comparing the first data having highest matched-degree and the second data, and providing the fitting result for the buyers.

9. The fitting device for fitting in the virtual environment of claim 1, comprsing:
an In obtaining unit obtaining buyer's ID;
a looking up record unit looking up historical records and shopping evaluation records according to the buyer's ID; and
a generating data unit generating second data according to the historical records and the shopping evaluation records.

10. The fitting device for fitting in the virtual environment of claim 9, comprsing: the generating data unit is configured as:
finding records for buying the clothes from the historical records;
obtaining evaluation for dimension of each of the bought clothes from the shopping evaluation records;
taking a weighted average for the dimension of each of the bought clothes having eligible evaluation, and obtaining dimension data as the second data.
